(19) United States
(12) Patent Application Publication
(10) Pub. No.: US 2005/0112979 A1
(43) Pub. Date: May 26, 2005

(54) Integrally formed absorbent materials, products incorporating same, and methods of making same

(76) Inventors: Lawrence Howell Sawyer, Neenah, WI (US); Gabriel Hammam Adam, Alpharetta, GA (US); Leon E. Chambers JR., Cumming, GA (US); Susan Kathleen Cobbs, Atlanta, GA (US); John Herbert Conrad, Alpharetta, GA (US); Michael Allen Daley, Appleton, WI (US); Richard Norris Dodge II, Appleton, WI (US); Peter Robert Elliker, Appleton, WI (US); Gregory Marc Lefkowitz, Gainesville, FL (US); Eric Edward Lennon, Roswell, GA (US); Kambiz Bayat Makoui, Neenah, WI (US); Debra Jean McDowall, Neenah, WI (US); Shannon Kathleen Melius, Appleton, WI (US); Sridhar Ranganathan, Suwanee, GA (US); Xiaomin Zhang, Appleton, WI (US)

Correspondence Address: KIMBERLY-CLARK WORLDWIDE, INC., 401 NORTH LAKE STREET, NEENAH, WI, 54956, US

(21) Appl. No.: 10/720,299

(22) Filed: Nov. 24, 2003

(51) Int. Cl. B32B 5/26; B32B 5/16

(52) U.S. Cl. 442/415; 442/416; 442/382; 442/417

(57) ABSTRACT

An in-line formed web or other material (such as foams) having major surfaces in the X-Y plane and a depth in the Z direction is suitable for use as an integral fluid distribution and fluid retention material in a disposable absorbent article. The web or material contains multiple zones of material which may have both thermoplastic fibers/materials and absorbent material components. The multiple zones can have different compositions of thermoplastic fibers/materials and absorbent material as applied in-line by various arrangements of thermoplastic melt dies and absorbent fiber/material dispensers. By arranging at least two of the multiple zones in an opposing relation overlaid in the Z-axis direction of the web/material, a gradient can be formed in the Z-direction of the web/material. In the case of airforming, by coordinating the timing and deposition of the material onto a forming wire, at least one of the multiple zones is arranged to have intermittent material deposition in at least one of a machine direction or a cross direction of the web. Thus the in-line formed integrated web has a Z-direction gradient of air laid material zones and zones of different materials intermittently placed in one of the machine direction or the cross direction and may be customized according to the specific need for a single overall structure having fluid intake, distribution and retention properties in an absorbent article.

### TECHNICAL FIELD

The invention pertains to absorbent materials. More specifically, the invention pertains to absorbent materials which provide both enhanced intake and preferential wicking of fluid to specific locations within the absorbent materials.

### BACKGROUND OF THE INVENTION

Disposable absorbent personal care products typically are made with a top sheet material (also referred to as a cover sheet or liner), an absorbent core (or liquid retention area) and a liquid impervious back sheet. Some products may also have one or more surge layers, a transfer delay layer, or other specialized layers or combination thereof, between the top sheet and absorbent core layers. Absorption of fluid, comfort and avoidance of leakage are the functions desired from such layers, and ultimately from such products.

An ideal absorbent product, such as the personal care products discussed herein in conjunction with the present invention, would have no or limited leakage, and deliver comfort and discretion to the user. Current personal care products may have relatively high leakage and thus offer only modest protection to the consumer.

Not wishing to be bound by theory, leakage can be categorized by three root causes. These causes include the possibility that fluid does not absorb into the product following its deposition in the product (i.e. at the time of insult) and in fact, runs off of the product, fluid is absorbed into the product at the time of insult, but subsequently leaves it, for instance, through the one or multiple product layers, or fluid never contacts the product.

The specific reasons for leakage may be expressed further in terms of definitive mechanisms. A product, for instance, may not have suitable space for absorption due to localized saturation in the insult target area, or low contact area for the insult. The product may not have a suitable driving force for absorption because the structure does not have the right balance of permeability and capillarity. The interfiber spaces of a particular layer may be partially full of liquid. Furthermore, fluid may contact the product and run-off. Finally, the fluid may be too viscous or the pores or interfiber spaces might not be large enough to allow fluid to pass through to the subjacent layer(s).

In all cases, the material systems, that is, the material in the layers that make up the product, and their concentration in a specific product design dramatically impact leakage. In the field of material systems design, leakage may also be a function of materials shaping and conformability as well as intake, distribution, retention and transfer.

“Intake” includes the initial absorption of fluid into a dry product as well as the continued uptake of fluid into the absorbent structure of a wet or insulted product. Development of superior intake systems requires an understanding of environmental conditions including the nature of the fluid and its discharge. Developing functional intake structures requires an understanding of material characteristics and their interaction with the fluid as components and systems of components, including interfaces and product design. Product design includes the arrangement and geometric design of material components and their interaction with the user's body and fluid (body exudates).

Initial intake of bodily fluids into an absorbent article is also somewhat dependent upon the characteristics of the liner or topsheet material and the upper absorbent layer, if there is one in the article. Intake of bodily fluid into these materials is a function of the material composition and material characteristics, including the void volume and fiber surface area, fiber orientation and fiber surface wettability. Essentially, the openness and/or capillarity impact the initial intake of fluid. These intrinsic material characteristics specifically define the more familiar material properties of permeability and capillarity, which can be calculated and measured by techniques well known in the art. In addition to the characteristics of the liner, a suitable intermediate layer and absorbent core may be matched to it and/or to each other in order to permit fluid communication and transfer and thus good fluid intake.

There thus remains a need for a personal care product that is able to contain body exudates in such a way as to keep the wearer comfortable and protected from fluid being expressed out of the absorbent article. Since new absorbent articles are moving in less bulky and thinner directions, and often include narrower chassis designs in a user's crotch area, the need to more efficiently move and store fluid is ever more evident.

As is known in the art, personal care absorbent articles/products such as diapers or other absorbent garments, are often constructed from multiple distinct or discrete layers of materials with each layer having a specialized function. For example, two common layers include the surge layer, specialized to provide temporary storage of fluid when “surges” of fluid arrive faster than the core, saturated or dry, can acquire the fluid, and the absorbent layer or core, which is specialized to hold and retain a high volume, or load, of liquid. However, the construction of garments with specialized layers, which may function very efficiently, may also lead to escalating product costs due to the expense of making and placing the multiple layers together in a garment. Thus, it is desirable that the fluid handling, or distribution layer and the fluid absorbent, or retention layer be easily manufactured and incorporated into a personal care product in an economical fashion. It is further desirable that such “layers” or “structural components” function efficiently and be matched together to perform in a certain desirable manner. It is still further desirable that such functionality be matched to also deliver targeted waste removal performance or other targeted performance enhancement.

### SUMMARY OF THE INVENTION

The integrally formed web or material of the invention contains at least two Z-direction (out of plane) zones and at least two X-Y (in-plane) zones. In one embodiment, the zone of the web/material in the area nearest where liquid enters the material, referred to as the target area or target zone, is designed to take in liquid rapidly. The zone of the web/material toward the distal ends of the material is designed to lock up liquid. The integral web/material may contain multiple X-Y planar zones of material, which may have binders, such as thermoplastic fibers, and absorbent material, such as pulp or suberabsorbent material or the like, as deposited in an airlaid process or other in-line manufacturing process that blurs the boundaries between zones. In addition, such processes may for example, be foam forming processes. The multiple zones may have different compositions of binders, such as, thermoplastic fibers, and absorbent material as applied in-line by various arrangements of thermoplastic melt dies and/or absorbent fiber dispensers, SAM feeders or the like. Such may be conveyed with pulp as well.

By arranging at least two of the multiple zones in an opposing relation (out of plane) overlaid in the Z-axis direction of the web/material, a gradient can be formed in the Z-direction of the web/material thereby providing fluid intake into the product as well as fluid distribution to move fluid or targeted waste, away from the area of insult when placed in that portion of the personal care product closest to the topsheet, or otherwise closest to the wearer, if the topsheet is not desired or necessary. Another area of the material/web may then provide fluid retention functions without the necessity of making, handling, and constructing separate layers together into the personal care product.

In an alternative embodiment, the integral web/material may have at least two out of plane zones in the Z-direction. In still another alternative embodiment, the integral web/material may have at least three in plane zones in an X-Y plane, and at least three out of plane zones in the Z-direction. In still a further alternative embodiment, the integral web/material may have at least three zones out of plane in the Z-direction, and at least two zones in plane (X-Y plane).

In still a further alternative embodiment, the integral web/material demonstrates zoning such that greater than 25 percent of the total liquid in the integral web/material is above 5 cm in height, after the second insult, with a run-off of less than 10 g in accordance with the MIST test (as described below). In still a further alternative embodiment, the integral web/material demonstrates zoning such that greater than 30 percent of the total liquid in the integral web/material is above 5 cm in height, after the second insult, with a run-off of less than 6 g in accordance with the MIST test. In still a further alternative embodiment, the integral web/material demonstrates zoning such that greater than 32 percent of the total liquid in the integral web/material is above 5 cm in height, after the second insult with a run-off of less than 4 g in accordance with the MIST test.

In still a further alternative embodiment, the integral web/material demonstrates zoning such that greater than 25 percent of the total liquid in the integral web/material is above 5 cm in height, after a third insult, with a run-off of less than 30 g in accordance with the MIST test. In still a further alternative embodiment, the integral web/material demonstrates zoning such that greater than 30 percent of the total liquid in the integral web/material is above 5 cm in height, after the third insult, with a run-off of less than 20 g in accordance with the MIST test. In still a further alternative embodiment, the integral web/material demonstrates zoning such that greater than 35 percent of the total liquid in the integral web/material is above 5 cm in height after the third insult, with a run-off of less than 15 g in accordance with the MIST test.

In still a further alternative embodiment, the integral web/material demonstrates zoning such that greater than 25 percent of the total liquid in the integral web/material is above 5 cm in height, after the fourth insult, with a run-off of less than 45 g in accordance with the MIST test. In still a further alternative embodiment, the integral web/material demonstrates zoning such that greater than 35 percent of the total liquid in the integral web/material is above 5 cm in height, after the fourth insult, with a run-off of less than 35 g in accordance with the MIST test. In still a further alternative embodiment, the integral web/material demonstrates zoning such that greater than 40 percent of the total liquid in the integral web/material is above 5 cm in height, after the fourth insult, with a run-off of less than 25 g in accordance with the MIST test.

In another alternative embodiment, an integrally formed absorbent web/material is composed of at least two “zones” in-plane and at least two “zones” out-of-plane with two adjacent “zones” having a z-directional permeability difference of at least 40 um². In still another alternative embodiment, an integrally formed absorbent material/web is composed of at least two “zones” in-plane and at least two “zones” out-of-plane with a target zone permeability of at least about 50 um². In still a further alternative embodiment an integrally formed absorbent material/web is composed of at least two “zones” in-plane and at least two “zones” out-of-plane in which two adjacent “zones” have different pulp fibers such that the coarseness ratio of the two fibers is >1.

In an airlaid process, by coordinating the timing of the material deposition onto a forming wire having a controlled area vacuum, at least one of the multiple zones can be arranged to have zones of intermittent material deposition in at least one of a machine direction or a cross direction of the web. In this fashion, an in-line formed material web has a Z-direction gradient of material zones and zones of different material intermittently placed in one of the machine direction or the cross direction, and may be customized according to the specific need for a single structure having fluid distribution and retention properties or other properties, in an absorbent article. Through the use of such a process, a zoned material can be produced with gradual transitions between zones, rather than the sharp borders common to discrete layered materials of a traditional laminate-type material, in which the separate layers are bonded or held to one another in some other fashion, such as a pledget using adhesive bonding. Through such a process, an efficient use of structural components may be employed to arrive at a desired product, rather than overcompensating unnecessary regions of a product with materials that are either not used or minimally used.

### BRIEF DESCRIPTION OF THE DRAWINGS

FIG. 1a illustrates a side cross-sectional view of a zoned integral material made in accordance with the present invention, with the MD, CD directions (collectively X-Y planes) and the Z direction noted.

FIG. 1b illustrates a top view of the material in FIG. 1a with the zones identified.

FIG. 1c illustrates a top view of in plane zones and out of plane zones separated.

FIG. 1d illustrates an example sample with a “pledget” material situated thereon.

FIG. 2 illustrates a side cross-sectional view of an alternative embodiment of a zoned integral material made in accordance with the present invention.

FIG. 3a is a graph which represents % Above 5 cm versus 2nd Insult Run-Off for various zoned integral materials in accordance with the invention, as well as comparative examples.

FIG. 3b is a graph which represents % Above 5 cm versus 3^{rd} Insult Run-Off for various zoned integral materials in accordance with the invention, as well as comparative examples.

FIG. 4 is a graph which represents % Above 5 cm versus 4th Insult Run-Off for various zoned integral materials in accordance with the invention, as well as comparative examples.

FIG. 5 illustrates a “cradle” used to perform some of absorbent system performance tests described herein.

FIG. 5a illustrates a cross section of the cradle of FIG. 5 with a numerical breakdown of height so as to envision liquid travel from the insult target area.

FIG. 6a illustrates a cross-sectional view of a “cup” used to perform the absorbent material permeability performance tests described herein.

FIG. 6b illustrates a general perspective view of a “cup” used to perform of the absorbent material permeability performance tests described herein.

FIG. 7 illustrates a bottom view of the piston of FIG. 6 used to perform some of the product permeability performance tests described herein.

FIG. 8 illustrates a cross-sectional view of an exemplary hand sheet former.

FIG. 9 illustrates a cross-sectional view of an exemplary fiber mixing vessel.

Repeat use of reference characters in the present specification and drawings is intended to represent same or analogous features or elements of the invention.

### DEFINITIONS

The term “disposable” includes being disposed of after a single, or limited, use and not intended to be washed and reused.

An “X-Y Zone” is defined as a generally recognizable combination of similar material types or function existing in the X-Y plane, that is along the MD and CD directions. The term “X-Y Zone” shall be synonymous with the term “in-plane” zone.

A “Z” direction zone shall be a zone out of plane with an X-Y Zone.

The “upward”, “upper”, or “top” position zones shall refer to a position within a product/article or material that would be closest to the body of a wearer than “downward”, “lower” or “bottom” zones when the article is worn. The term “lower” shall refer to a position within a product/article or material that would be closest to the wearer's garments, as opposed to the wearer.

The term “subjacent” is defined to mean a lower zone which is below an upper zone in the Z-direction. The term “adjacent” is defined to mean a zone which is next to or side by side another zone in the X-Y plane.

The term “composite” is defined as having two or more components. It may be used interchangeably, depending on the context, with the term “material”. In describing integral materials, the description shall also apply to integral webs and integral foams, except where noted.

As used herein and in the claims, the term “comprising” is inclusive or open-ended and does not exclude additional unrecited elements, compositional components, or method steps.

As used herein the term “nonwoven fabric or web” means a web having a structure of individual fibers or threads which are interlaid, but not in an identifiable manner as in a knitted fabric. Nonwoven fabrics or webs have been formed from many processes such as for example, airlaying processes (known as “airlaid”), meltblowing processes, spunbonding processes, coform and bonded carded web processes. The basis weight of nonwoven fabrics is usually expressed in ounces of material per square yard (osy) or grams per square meter (gsm) and the fiber diameters useful are usually expressed in microns or denier. (Note that to convert from osy to gsm, multiply osy by 33.91).

“Spunbond fibers” refers to small diameter fibers that are formed by extruding molten thermoplastic material as filaments from a plurality of fine capillaries of a spinneret and then drawn by air. Such a process is disclosed in, for example, U.S. Pat. No. 3,802,817 to Matsuki et al., and U.S. Pat. No. 4,340,563 to Appel et al. which are incorporated by reference herein in their entirety. The fibers may also have shapes such as those described, for example, in U.S. Pat. Nos. 5,277,976 to Hogle et al. which describes fibers with unconventional shapes and which is incorporated by reference herein in its entirety.

The term “airlaying” refers to a well-known process by which a fibrous nonwoven layer can be formed. In the airlaying process, bundles of small fibers having typical lengths ranging from about 1 to about 19 millimeters (mm) are separated and entrained in an air supply and then deposited onto a forming screen, usually with the assistance of a vacuum supply. The randomly deposited fibers then are bonded to one another using, for example, hot air when a thermal binder is used, water compaction, or a spray adhesive (latex). Airlaying is taught in, for example, U.S. Pat. No. 4,640,810 to Laursen et al. which is incorporated by reference herein in its entirety. Air laying may include coform deposition which is a known variant wherein pulp or other absorbent fibers are deposited in the same air stream onto the forming screen. The screen may also be referred to herein as a forming wire. If the term “airformed” is used, it is meant to designate material that has been formed similarly to airlaid, but without the use of a binder.

“Personal care product or article” means diapers, wipes, training pants, absorbent underpants, swimwear, adult incontinence products, feminine hygiene/feminine care products, wound care items like bandages, mortuary, and veterinary and other articles.

Words of degree, such as “about”, “substantially”, and the like are used herein in the sense of, at, or nearly at, when given the manufacturing and material tolerances inherent in the stated circumstances, and are used to prevent the unscrupulous infringer from unfairly taking advantage of the invention disclosure where exact or absolute figures are stated as an aid to understanding the invention.

As used herein, the term “machine direction” or MD means the length of a fabric in the direction in which it is produced. The term “cross direction” or “cross machine direction” or CD means the width of fabric, i.e. a direction generally perpendicular to the MD. These terms may also designate, depending on the context, the direction of a product from front to back (MD) or side to side (CD) in an X-Y planar direction. The Z-direction shall mean the direction of the product in the thickness (vertical) direction.

The phrase “in-line” shall be synonymous with “on-line“ ” and shall refer to a continuous process for forming an integral web or other material on a single forming line, as opposed to a material constructed from multiple webs or materials formed on multiple lines and then put together as component/discrete pieces. The boundaries of such webs or materials from which the overall in-line material is constructed are blurred, in that they gradually transition from one zone or region to another.

The phrases “integral web,” “integrally formed web”, “integrally formed absorbent web,” “integrally formed absorbent material”, and “integrally formed material” refer to a web or material (such as for example, foams) that is formed in-line in which there is somewhat of an overlap/intermixing or entanglement of fibers or material components (such as cell characteristics in the case of foams) between each zone within the web or material, as opposed to crisp, discrete material boundaries common to traditional laminates. In such an integral web/material, there is a somewhat gradual transition between in plane zones in either the X-Y planes or in the Z direction (out of plane), through upper and lower adjacent X-Y planes. Such materials have liquid communication between zones.

The phrase “discrete material boundaries” refers to boundaries formed between separate identifiable layers such as resulting from post-processing after layer formation, including, but not limited to, such processing as applying adhesives to bond separate layers, applying interlayer films or tissues, and thermal or mechanical bonding of layer boundaries creating discrete bonding lines.

The term “zone” refers to an area or region of relatively uniform material composition or concentration, or both, occurring either in the plane of the X-Y axis, e.g., in an X-Y Zone, but which area may have blurred edges as it contacts an adjacent zone, or alternatively in the Z (thickness) direction between an upper X-Y zone and a lower X-Y out of plane zone.

The term “gradient” refers to a change of material composition/properties or concentration, or both, occurring in the Z-axis, e.g. between upper and subjacent X-Y zones, or between adjacent X-Y zones. Such a gradient of material properties may include differences in capillary tension, density, permeability, and absorbency, which is normally achieved through different materials or processing conditions, such as distinct layers.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., and U.S. Pat. No. 5,336,552 to Strack et al. which are incorporated herein in their entirety. Conjugate fibers are also taught in U.S. Pat. No. 5,382,400 to Pike et al., which is incorporated by reference herein in its entirety, and may be used to produce crimp in the fibers by using the differential rates of expansion and contraction of the two or more polymers. For two component fibers, the polymers may be present in varying desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes, and which are each incorporated by reference herein in their entirety.

The phrases “feminine hygiene products” or “feminine care products” mean sanitary napkins or pads, towels, tampons and panty-liners.

The phrases “target”, “target point”, “target region”, “target area” or “target zone” are each used synonymously and refer to the area or location on a personal care product where an insult is normally delivered by a wearer, or a nozzle in an experimental test method. It is usually situated at a location closest to the skin of a consumer and farthest from the garment side of a product.

The term “user side” shall refer to the upper location of a material that is closest to the skin of a wearer when such product or material within such product is being used.

The term “garment side” shall refer to the lowest location of a material that is closest to the garment of a wearer when such product or material within such product is being used. The garment side location within a material is usually separated from the user's garment by an outer cover barrier material, such as a film material.

The term “contact area” refers to the area to which an insult may be exposed during fluid intake into a personal care product, or where the nozzle is placed in experiments, such as by using a cradle method.

The term “insult” refers both to the natural deposition of a body exudate, and in particular urine or menses liquids during personal care product use by a consumer, as well as the deposition of simulated body exudates during personal care product testing.

The term “thermoplastic” shall refer to a polymer that softens when exposed to heat and solidifies when cooled to room temperature.

The term “superabsorbent material” or “SAM” shall refer to a water swellable, water insoluble organic or inorganic material capable, under the most favorable conditions, of absorbing more than 15 times its weight in an aqueous solution containing 0.9 weight percent sodium chloride. Organic materials suitable for use as a superabsorbent material of the present invention may include natural materials such as agar, pectin, guar gum, and the like; as well as synthetic materials, such as synthetic hydrogel polymers. Such hydrogel polymers include, but are not limited to, alkali metal salts of polyacrylic acids, polyacrylamides, polyvinyl alcohol, ethylene maleic anhydride copolymers, polyvinylethers, hydroxypropylcellulose, polyvinymorpholinone, polyvinylpyrrolidone; and polymers and copolymers of vinylsulfonic acid, polyacrylates, polyacrylamides, polyvinylpyridine, and the like. Other suitable polymers include hydrolyzed acrylonitrile grafted starch, acrylic acid grafted starch, and isobutylene maleic anhydride copolymers and mixtures thereof. It should be recognized that copolymers of combinations of the above materials and physical mixtures of combinations of the above materials may also be included. These hydrogel polymers are desirably lightly crosslinked to render the material substantially water insoluble. Crosslinking may, for example, be by covalent, ionic, van der Waals, or hydrogen bonding. The superabsorbent materials may be in any form suitable for use in absorbent composites including particles, fibers, flakes, spheres, films, and the like.

Test Methods

Fiber Coarseness

Fiber length and coarseness can be measured with a Fiber Quality Analyzer from OpTest Equipment Inc. of Hawkesbury, Ontario, Canada by using the method described in the operating manual. This method is generally as follows. Coarseness is measured by taking approximately one gram of oven dried (OD) fiber and disintegrating the fiber in 2000 ml of water. After disintegration, enough water is added to obtain a 0.01 percent consistency. The solution is then kept mixed with an electric stirrer. Enough of the solution is then pipetted out with a large opening pipette to have 0.5 mg of OD fiber, which is added to a Fiber Quality Analyzer (FQA) beaker, which is filled with water. The beaker is then placed on the FQA and the sample is analyzed. The FQA measures the length of the fiber and the weight of the fiber is entered manually into the program which then calculates coarseness in units of milligrams of fiber per 100 m of fiber.

Material Permeability Test:

“Permeability” as defined by this application can be calculated using Darcy's law which is considered valid for linear, slow steady state fluid movement through a porous medium. The law states that fluid flow is related to the structure of the material, the pressure applied to drive the fluid, the viscosity of the fluid, the permeability of the absorbent core, and the length of the composite in that direction. Equation 1, which follows, is used to calculate composite permeability (K) in (cm²) where H is the height (thickness) of the composite after swelling in cm, Q is the mass flow rate in g/s, μ is the fluid viscosity in poise, A is the cross-sectional area in cm², ρ is the fluid density in g/cm³, and ΔP is the hydrostatic head in dyne/cm². Through conversion factors the material permeability is reported in squared microns.

$$K = \frac{H \cdot Q \cdot μ}{A \cdot ρ \cdot Δ P} \qquad ( Equation 1 )$$

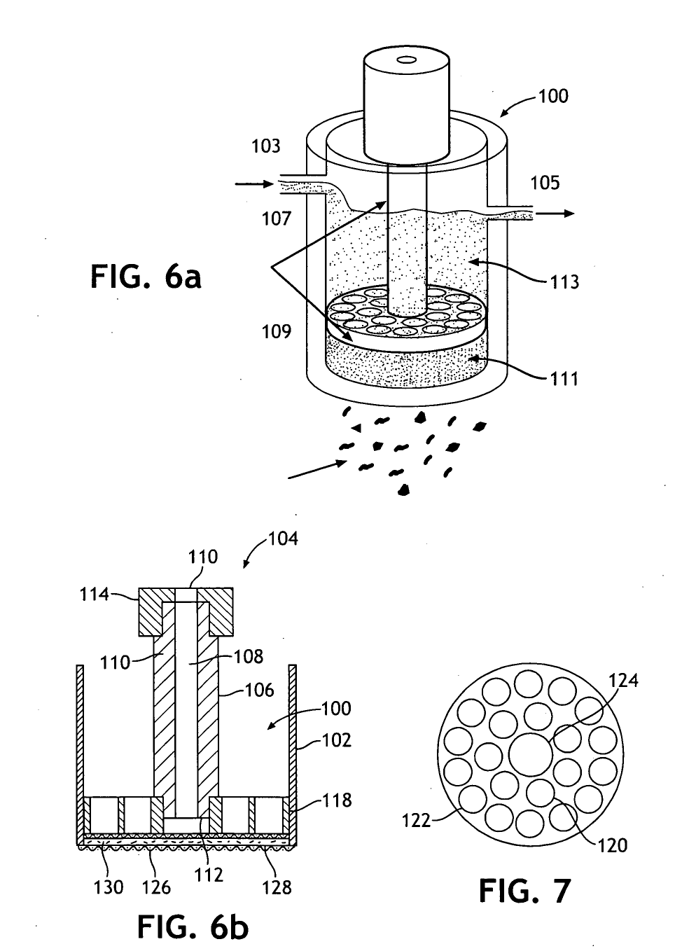

For the purposes of the examples, permeability studies were conducted using permeability cups as illustrated in FIGS. 6b-7. The material permeability cups which are illustrated in FIGS. 6b and 7 are designed to have a 4 cm head of fluid, or 3923 dynes/cm², during testing as measured from the bottom screen of the cup. As can be seen generally in FIG. 6a, the permeability cup 100 may include a fluid entrance 103 and exit 105. Alternatively, fluid may be poured in through the top. A perforated piston 107, 109 with weight is positioned in the cup, situated over the swollen material sample 111. 0.9% NaCl Saline 113 is maintained in the cup and flows through the cup from the entrance to the exit. Additionally, the saline flows through the material and passes out the bottom of the cup 100. Alternatively, fluid may flow out only through the bottom of the cup as seen in FIG. 6b.

Specifically, a particularly suitable piston/cylinder apparatus for performing the material permeability is shown in FIG. 6b. Referring to FIG. 6b, apparatus 100 consists of a cylinder 102 and a piston generally indicated as 104. As shown in FIG. 6b, piston 104 consists of a cylindrical LEXAN shaft 106 having a concentric cylindrical hole 108 bored down the longitudinal axis of the shaft. Both ends of shaft 106 are machined to provide ends 110 and 112. A weight, indicated as 114, rests on end 110 and has a cylindrical hole 116 bored through the center thereof. Inserted on the other end 112 is a circular piston head 118. Piston head 118 is sized so as to vertically move inside cylinder 102.

As shown in FIGS. 6b and 7, piston head 118 is provided with inner and outer concentric rings containing seven and fourteen 0.95 cm (0.375 inch) cylindrical holes, respectively, indicated generally by arrows 120 and 122. The holes in each of these concentric rings are bored from the top to bottom of piston head 118. Piston head 118 also has cylindrical hole 124 bored in the center thereof to receive end 112 of shaft 106.

Attached to the bottom end of cylinder 102 is a 100 micron mesh stainless steel cloth screen 126 that is biaxially stretched to tautness prior to attachment. Attached to the bottom end of piston head 118 is a No. 125 micron mesh stainless steel cloth screen 128 that is biaxially stretched to tautness prior to attachment. A sample of absorbent material indicated as 130 is supported on screen 126.

Cylinder 102 is bored from a transparent LEXAN rod or equivalent and has an inner diameter of 6.00 cm (area=28.27 cm²), a wall thickness of 0.5 cm, and a height of 5.0 cm. Piston head 118 is machined from a LEXAN rod. It has a height of 0.625 inches (1.59 cm) and a diameter sized such that it fits within cylinder 102 with minimum wall clearances, but still slides freely. Hole 124 in the center of the piston head 108 has a threaded 0.625 inch (1.59 cm) opening (18 threads/inch) for end 112 of shaft 106. Shaft 106 is machined from a LEXAN rod and has an outer diameter of 0.875 inches (2.22 cm) and an inner diameter of 0.250 inches (0.64 cm). End 112 is 0.5 inches (1.27 cm) long and is threaded to match hole 124 in piston head 118. End 110 is 2.54 cm (1 inch) long and 1.58 cm (0.623 inches) in diameter, forming an annular shoulder to support the stainless steel weight 114. The annular stainless steel weight 114 has an inner diameter of 1.59 cm (0.625 inches), so that it slips onto end 110 of shaft 106 and rests on the annular shoulder formed therein. Permeability samples were swollen with the plunger in place (piston). The piston weight is 60 g, or approximately 0.03 psi.

When solutions flow through the piston/cylinder apparatus, the cylinder 102 generally rests on a 500 micron sieve tray or equivalent.

The piston and weight are placed in an empty cylinder to obtain a measurement from the bottom of the weight to the top of the cylinder. This measurement is taken using a Mitutoyo Model CD-6 caliper readable to 0.01 mm plus or minus 0.001. This measurement will later be used to calculate the height of the swollen material. It is important to measure each cylinder empty and keep track of which piston and weight were used. The same piston and weight should be used for measurement when the sample gel/material is swollen.

The permeability measurement is initiated by adding the 0.9% NaCl saline solution to cylinder 102 until the solution attains a height of 4 cm above the bottom of the sample material 130. This solution height is maintained throughout the test. The quantity of fluid passing through the sample material 130 versus time is measured gravimetrically. Data points are collected every second for the first two minutes of the test and every two seconds for the remainder. When the data are plotted as quantity of fluid passing through the bed versus time, it becomes clear to one skilled in the art when a steady flow rate has been attained. Only data collected once the flow rate has become steady is used in the flow rate calculation.

The flow rate, Q, through the material 130, is determined in units of g/sec by a linear least-square fit of fluid passing through the sample material (measured in grams) versus time (in second) Permeability (in cm²) is obtained by the following equation:
K=[Q*(H*Mu)]/[A*Rho*P]
where K=Permeability (cm²); Q=flow rate (g/sec); H=height of absorbent composite (cm); Mu=liquid viscosity (poise); A=cross-sectional area for liquid flow (cm²); Rho=liquid density (g/cm³); and P=hydrostatic pressure (dynes/cm²) (normally 3923 dynes/cm²).
Procedure For Permeability Test Method Utilized on Material Examples:
1. Samples are first cut into 2⅜″ diameter disks. The samples are taken from either the zone of interest or the target zone (measures determined at center or low point of absorbent in use, measuring 1 to 3 inches forward from these region. All materials not composing the absorbent core (i.e. liner, surge, tissue, cover, etc.) and were carefully removed from the sample.
2. Weigh samples dry and recorded the weight in grams.
3. Use a digital Mitutoyo caliper or similar apparatus to determine the distance between the top of the sample cup and the top of the piston for the sample cup.
4. Remove the piston from the cup holder and place the material samples inside the holder.
5. Place the piston inside the cup holder gently without applying pressure.
6. Measure the dry bulk reading (inches) using a digital caliper and record.
7. Place the sample cup holders inside Petri dishes on top of screens.
8. Fill Petri dishes with 0.9% NaCl saline and began timer for 30 minutes. Monitor the saline level to maintain a reservoir for the sample.
9. After the 30 minute soak, place a weight on the piston for a total applied pressure of 0.3 psi and measure the wet bulk using the digital caliper.
10. Record wet bulk.
11. Place the sample cup holder in the middle of the support screen and using a level make sure the sample cup holder is level.
12. Pour fluid into the sample cup holder to maintain 4 cm of fluid head on the material sample for 20 minutes.
13. Using a computer data acquisition system (such as capable of data transfer), determin the flow rate Q (g/sec) of saline through the sample. From this permeability may be calculated using Darcy's law as described above.
   Multiple Insult Spreading Test (MIST Evaluation): Cradle Test Method

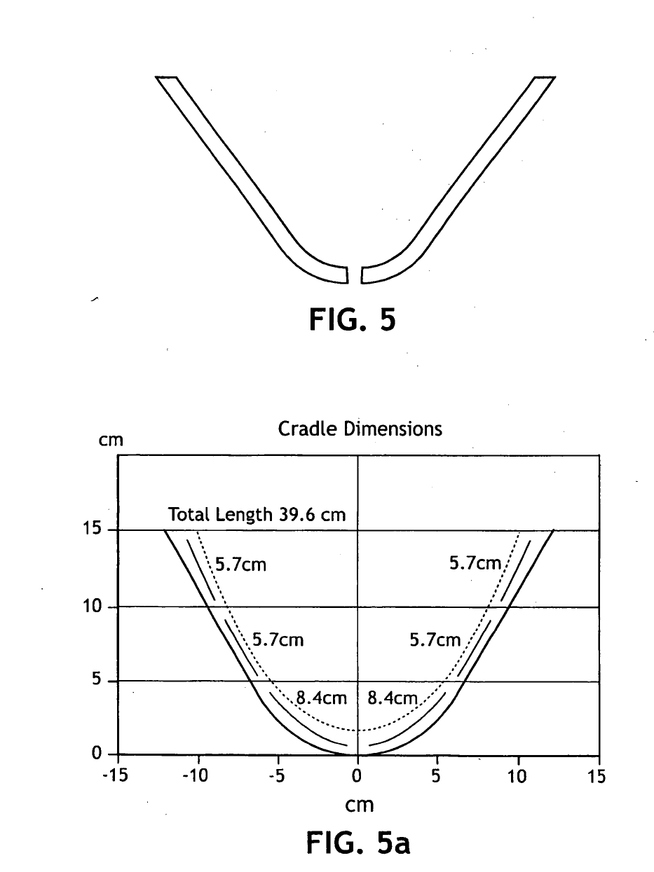

The purpose of this test is to measure runoff and distribution of fluid in absorbent materials in a vertical cradle configuration, such as that which exemplifies the types of conditions a personal care product will experience in use. This test is particularly suited for capillary based systems. An exemplary cradle is shown in FIG. 5. In this test an absorbent material or structure is placed in an acrylic cradle to simulate body curvature of a user such as an infant in either the standing or sitting configuration. The cradle has a width into the page of the drawing as shown of 33 cm and the ends are blocked, a height of 19 cm, an inner distance between the upper arms of 30.5 cm and an angle between the upper arms of 60 degrees. The cradle has a 6.5 mm wide slot at the lowest point running the length of the cradle into the page.

The material to be tested is placed on a piece of polyethylene film the same size as the sample and placed in the cradle. The material to be tested is insulted as noted by a nozzle normal to the center of the material and about 1/4 inch (6.4 mm) above the material unless otherwise noted. The amount of runoff is recorded. The nozzle is typically 2 inches forward from center. In the case where commercial diaper samples are tested, the original shape of the absorbent was not altered.

Equipment Needed for Test Method:

1. Plexiglas or LEXAN cradle in vertical test configuration with open slit on bottom of cradle as illustrated in FIG. 5.
2. Runoff tray and balance
3. Fluid pump set to deliver 60 milliliters at 15 gram/second rate through 3 mm orifice nozzle (check calibration daily)
4. 0.9% NaCl saline at room temperature
5. X-ray apparatus for fluid imaging
6. 0.05 psi bulk meter with 3 inch diameter platen
7. Sharpie marker, ruler, timer
8. Polyethylene film material
9. Absorbent core having been marked at middle of x-y plane and 2” forward from that point (insult point)
   Procedure for Test Method:
1. Cut a sheet of polyethylene to shape of absorbent material and place under absorbent material.
2. Mark center point of the absorbent for bottom of cradle and marked 2 inches to front of that point for target point.
3. Determine initial product weight and bulk at the target point using 0.05 psi, bulk tester with 0.001 mm accuracy. Note that if the target area is less than 3 inches wide the actual pressure under which the bulk is measured will be slightly higher.
4. Place the diaper or material sample in the cradle such that the marked center point was centered in the bottom of the cradle.
5. Insult 60 milliliters of saline at 15 cc/sec directed at the marked insult point, or another volume as noted.
6. Record the amount (grams) of fluid runoff that occurred. If there is run-off, add the fluid runoff back into the diaper sample at the insult point until the entire amount is absorbed. (If runoff fluid is not able to be taken in by the absorbent, stop test)
7. Wait 25 minutes following the fluid insult. Remove the sample from the cradle and acquire an x-ray image of the sample laid flat.
8. Determine the bulk of target area using 0.05 psi bulk meter after x-ray and before next insult.
9. Return the sample to the cradle for the next insult.
10. Continue loading the remaining samples at 30 minute intervals (timed from initiation of insults). Record the amount of runoff that occurs at each insult (or intake time). Continue taking x-rays of the sample 25 minutes after each insult and adding fluid runoff back into the absorbent sample as appropriate.
11. Test a minimum of three absorbents per code at total fluid loads of 60, 120, 180, 240, 300, milliliters corresponding to one through five insults, or other volumes as noted.
12. Record final wet weight of the sample.
   Fluid Distribution Analysis Details:

The middle 16.8 cm (lengthwise) of the sample material is the amount below 5 cm of height in the cradle. The tests were focused on the ability of the material to direct/move liquid to above the 5 cm height (FIG. 5a).

In order to quantify the ability of an absorbent system to distribute fluid outside of the target zone the system must transport the fluid vertically to the distal ends of the absorbent. One method for quantifying the ability of a material to do this is to measure the percentage of fluid transported above a given height, or 5 cm in this instance. Using the cradle disclosed in FIG. 5, and further represented by FIG. 5a, one can see that this cut-off occurs 8.4 cm from the center of the absorbent (on either side of the center). In these examples the amount of fluid greater than 8.4 cm from the outside of the center 16.8 cm center of the absorbent was divided by the total amount of fluid in the absorbent material.

This value was calculated by using x-ray imaging of the intact absorbent material between fluid insults using the cradle test described above. The x-ray imaging test is one method used to quantify the amount of liquid in each of several zones of absorbent systems. X-ray imaging is known in the art as discussed, for example, in an article entitled “Liquid Distribution: comparison of X-ray imaging Data”, by David F. Ring, Oscar Lijap and Joseph Pascente in Nonwovens World magazine, summer 1995, at pages 65-70. Generally, this procedure compares x-ray images of a wet and dry sample in order to calculate the liquid content. Such x-ray systems are available from Tronix Inc. of 31 Business Park Drive, Branford, Conn. 06045 as model no. 10561 HF 100 w/enclosure. This system uses software from Optimas Inc., of Ft. Collins, Colo. as Bio-scan Optimate®.

Other systems include Pantak systems of East Haven, Conn. Such systems may use an x-ray system to generate an image on a scintillator plate and record the image via a digital camera for comparison. Typical x-ray sources may be run at 30 kV and 12 mA. See in this regard, U.S. Pat. No. 5,843,063 to Anderson et al., which is incorporated by reference herein in its entirety. Other systems are available from LIXI Inc. of Downers Grove, Ill. under the designation SA-100-2 Series Model HLA-40-440MO2. It is also known in the art to determine the water content of a specific region of an article by nuclear magnetic resonance spectroscopy. Finally, it is possible to determine an estimate of water content in regions by conducting actual physical weight measurements at different stages of insult. Of course, to determine such regions weights, it will be necessary to isolate regions from the article as a whole and therefore it may be required that the article be altered or destroyed in the process.

The x-ray method above results in a gray scale image which can be used to determine the fluid amount located in different regions within the absorbent. The advantage of such an analysis is that it is non-destructive, and therefore allows quantification of the fluid location and while remaining ready for subsequent insults.

The x-ray data generates a fluid distribution profile showing amount of fluid in segments of product, along the length of the absorbent system. In this instance, a flat profile on a resulting graph would be indicative of good distribution.

Hand Sheet Formation for the Purposes of Examples:

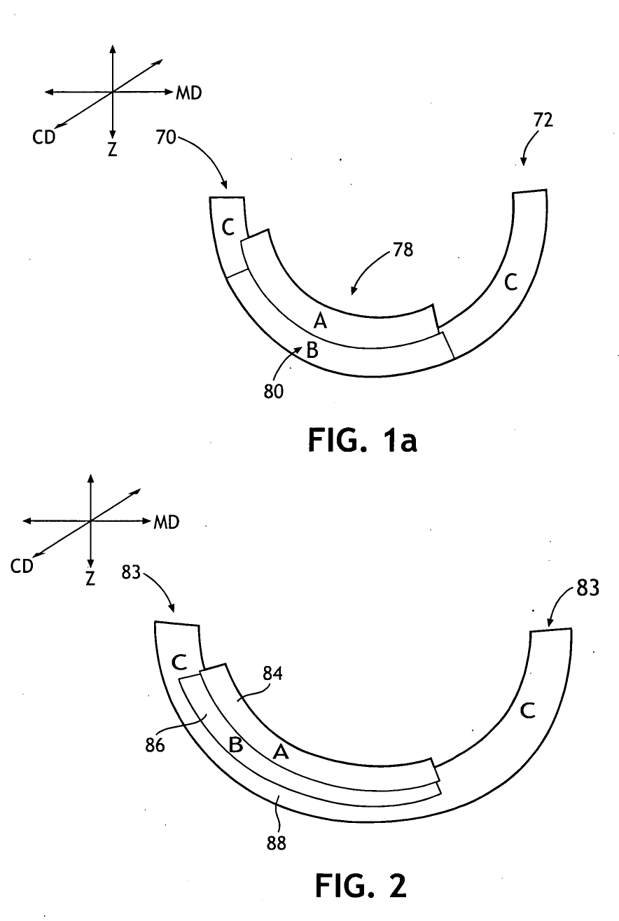

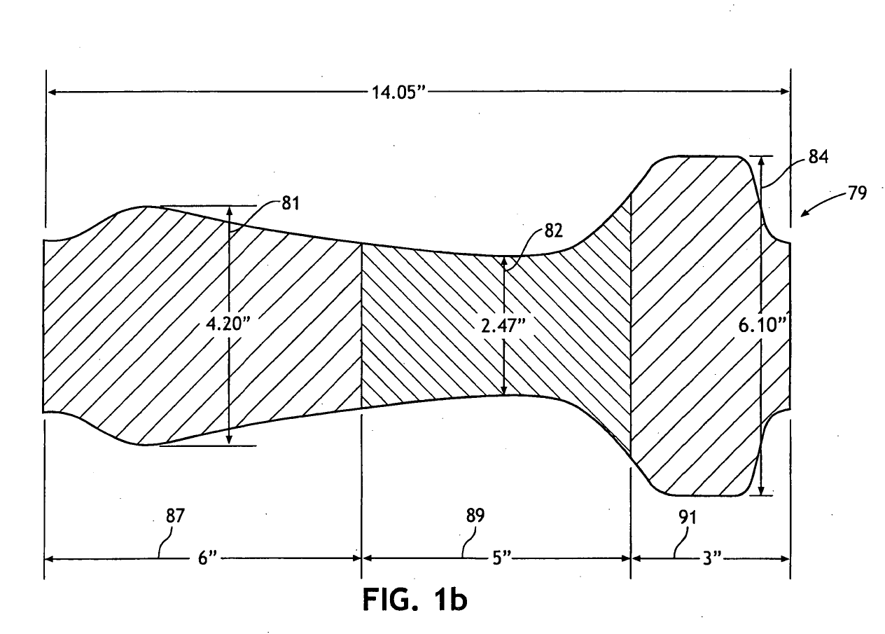

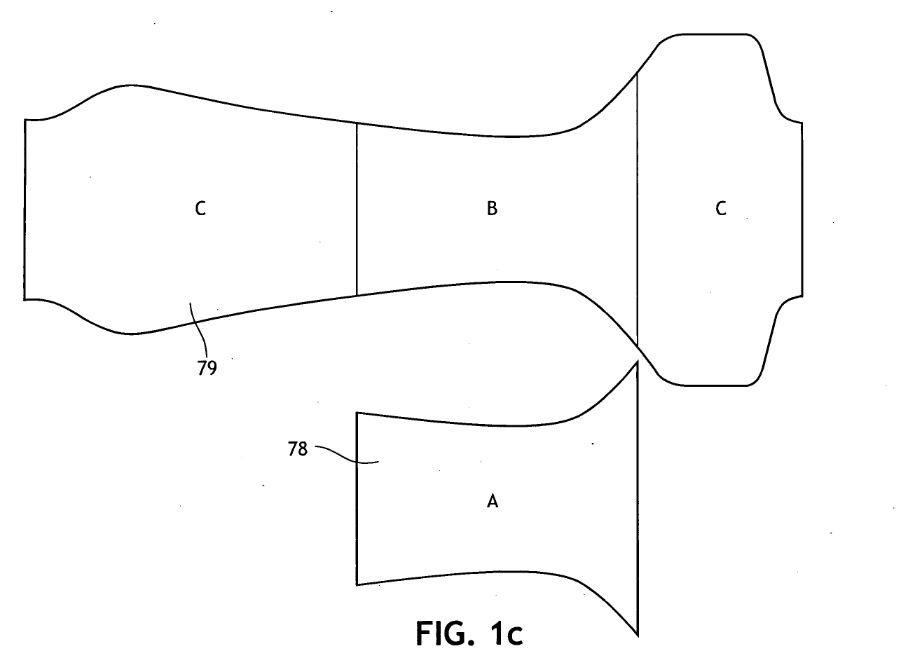

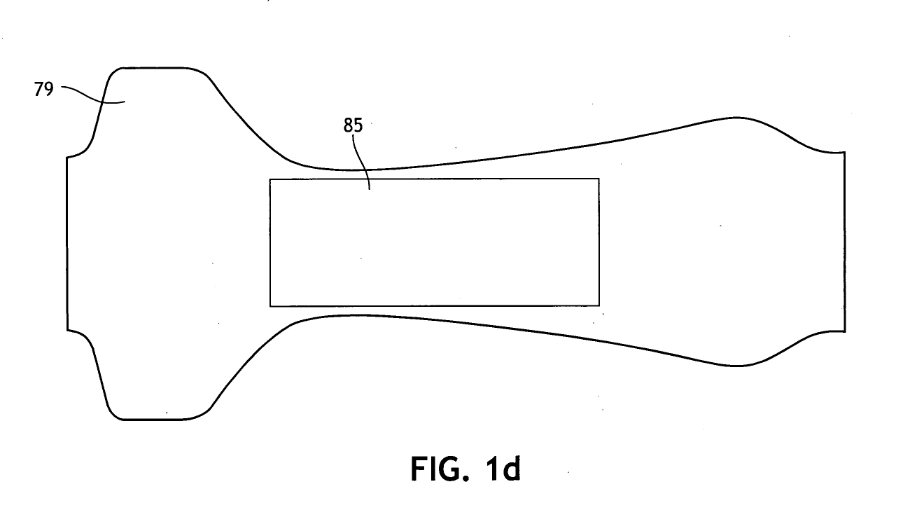

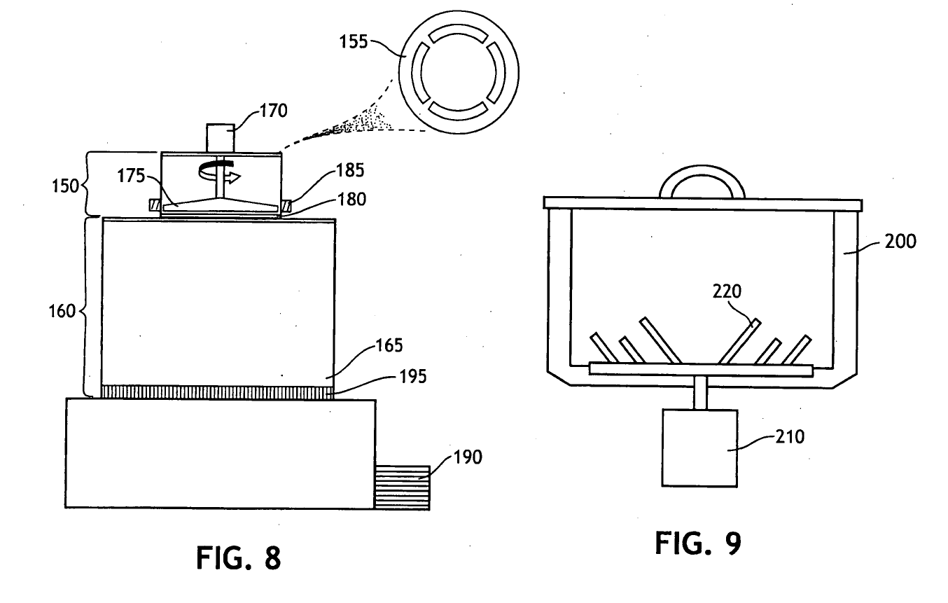

For the purposes of the examples, hand sheets of various materials were made using a hand sheet former (HSF) as shown in FIG. 8. The hand sheet former used for this study produced finished materials measuring approximately 17 by 17 inches. The hand sheets were cut into the shapes as described by FIG. 1b, with the zones in the respective locations. The hand sheet former, as illustrated in FIG. 8, is an airlaying apparatus composed of two primary sections: a fiber opening section 150 and a forming section 160. The forming section includes an entry port 155 for addition of fibers and/or particulate, a mechanical agitator consisting of a motor such as a ¼ hp motor capable of turning a blade 175 at 200-300 rpm, a second agitator capable of sequentially pulsing air at 40 psi from 6 dual ports 185 located equidistance around the perimeter of the opening section, and a perforated metal plate 180 to insure the fibers have been sufficiently opened prior to entering the forming section. The forming section consists of a 5 hp blower 190, capable of conveying air at 1400 cubic feet per minute, for drawing the fibers and/or particulate onto the forming surface 165 contained at the bottom of the hand sheet former, and an air blocking drawer 195 which allows for localized deposition of the entrained fibers and particles.

Fiber Mixing Vessel (FMV)

The fiber mixing vessel (FMV) is for mixing fibers prior to feeding them into the hand sheet former. It is especially important when putting two fibers, such as pulp and binder or two different pulps, into a single airformed layer that they be thoroughly mixed using the FMV prior to feeding them into the hand sheet former. All pulp should be fiberized using a Kamas, or similar fiberizer, prior to feeding into the hand sheet former or the fiber mixing vessel. As is known in the art, addition requirements should be calculated to obtain the desired basis weight of all species of fibers and particles. The fiberized pulp and opened staple fibers are then added to the FMV. Both fiber types should be broken into small pieces by hand to improve mixing and then placed into the FMV. The top is then placed on the FMV and the unit is turned on. The unit is operated for approximately 5-10 minutes, mixing at about 30%. An exemplary fiber mixing vessel is illustrated in FIG. 9, which includes a vessel for mixing 200, a motor 210, such as a variable speed 1 hp motor with approximately 2000 rpm speed, and including mixing blades or rods 220 designed not to damage the fibers.

Hand Sheet Preparation

Hand sheet production was employed for examples of absorbent materials of interest. In order to produce hand sheets, fibers were first mixed in the FMV to achieve homogenous mixture of thermal binder fiber and pulp. If zoning was intended, the blocking drawer 195 of the hand sheet former was blocked off so that air only flowed where material deposition was desired. This can be accomplished by using something as simple as tape and card board or any other manner of interest. A tissue carrier sheet was placed at the bottom of the forming chamber in order to capture fibers and particles as they fell through the forming chamber.

If zoning is desired, one should also place cardboard or another airflow inhibitor over previously formed zones to block airflow in a manner consistent with the forming surface blocking described above. Additionally, there should be overlap between in-plane zones of at least 0.25 inch and preferably 0.5-1.0 inch. This facilitates transfer between zones.

In operation, the hand sheet former was turned on, including the vacuum, air pump, and mixing blades to facilitate good formation. The fiber (which had been mixed in the FMV) and particulate are then added. In order to facilitate homogenous mixing, the total weight of fiber should be divided into at least 4 batches and SAM or other particles into at least 3 batches. This should be done such that there is one more batch of fibers than particles and so that no batch exceeds 12 g. This allows each zone or layer to start and finish with a fiber batch, enhancing the particulate containment. The number of batches will depend on the amount of material used. When all batches have been added, another zone may be formed as necessary.

Following airlaying using the hand sheet former (HSF) the samples were heated to activate the binder fiber and pressed to set the desired density. Activation was achieved by placing the sample in a Blue M Power-O-Matic 60 oven (distributed by Blue M. Electric Company of Blue Ispeak, Ill.) at 175° C. for 2 minutes. The materials were immediately transferred into a Carver Press with both the top and bottom platens heated to 105° C. The pressure and dwell time were varied to achieve the desired density for each zone. In instances where a simple layer contained multiple zones (i.e. B and C) at different thicknesses the zone with the greater thickness was densified first followed by the thinner zones. In the case of C-B-C laminates (as seen in FIG. 1a), zone B was densified first and then the two zone C's were densified individually.

### DETAILED DESCRIPTION

This invention applies to the use of zoned absorbent integral webs or other integral materials to provide improved fluid evacuation from a target region within the absorbent core of an absorbent personal care article and still provide good intake. Additionally, this invention applies to the use of zoned integral webs or other materials to provide other functionalities to an absorbent article. Previously known structures can only provide one of these functionalities, but not both. By changing the composition within, and/or throughout the absorbent material, functionality can be improved in an absorbent article system. Examples of such improvements include providing enhanced intake, as well as ensuring that fluid can be preferentially wicked to desired locations in the absorbent article. Such a system distributes fluid more uniformly along the length of a diaper, for instance, resulting in improved functional performance to the consumer and the more efficient utilization of raw materials within the product. By matching the material properties of materials of different integral zones (in both horizontal in-plane and vertical out of plane directions) an efficient absorbent material and subsequent article can be produced.

The invention also applies to the particular use of raw materials within an absorbent system to deliver improved fluid distribution, and/or other targeted waste distribution. These materials can be arranged within the absorbent system such that desirable properties are located in zones/regions where they are most needed/effective. This could be accomplished by zoning the material in the x-y plane or several x-y planes, one atop the other in the Z-direction or combinations of both, such that improved functionality, or efficiency is achieved. The desired outcome is a thinner product with rapid intake achieved through improved fluid retention, and efficiency through distributing fluid throughout the absorbent core. The absorbent system can be produced in a single process as an integral web or foam, by multistage forming and/or in-line stations.

The invention also applies to the placement of zones within an absorbent material system such that insults within a product utilizing the system are focused on directing fluid at least 5 cm above the low point of a product when in use. Desirably such liquid is directed to the outer edges of the product that are highest from the insult target area, when the product is in an upright position (such as when a user, i.e. infant/child/adult, is sitting in an upright position or standing in an upright position).

The absorbent materials of this invention, as further explained below, may be desirably made using an airlaid process. Alternatively, such integral materials may be manufactured using other in-line processes such as via foam manufacturing processes. The production of airlaid nonwoven materials is well defined in the literature and documented in the art. Examples include the Dan-Web process as described in U.S. Pat. No. 4,640,810 to Laursen et al. and assigned to Scan Web of North America Inc., the Kroyer process as described in U.S. Pat. No. 4,494,278 to Kroyer et al. and the process described in U.S. Pat. No. 5,527,171 to Soerensen assigned to Niro Separation as well as the method of U.S. Pat. No. 4,375,448 to Appel et al. assigned to Kimberly-Clark Corporation, each of which is hereby incorporated by reference in their entirety. Each example is provided by way of explanation of the invention, not limitation of the invention.

In an exemplary practice of this invention an absorbent material having at least two MD/CD X-Y plane zones (and at least two out of plane Z direction zones) is produced by the air laid process. Desirably, the absorbent material includes at least three MD/CD x-y plane zones. The number of zones may be limited by equipment constraints as most airlaying equipment currently available generally have three to seven banks of airlaying heads. However, the present invention should not be considered as so limited if it is economical or otherwise practical to produce alternative fiber deposition equipment. Further, the person having ordinary skill in the art will recognize that other forms of deposition, such as air-formed processes without thermoplastic binders, may be practiced according to the present invention.

Desirably, the material has at least two out of plane Z direction zones. The material generally has denominated an upper X-Y zone and a lower X-Y zone in the Z direction wherein the upper zone is the zone closer to the body of a wearer while the personal care product is in use. The integral zoned web may have various gradients between zones in the Z, or thickness, direction, including e.g., having a gradient of increasing density in the direction away from the wearer when the product is in use or otherwise. The major axes of the web will be indicated in the drawings where appropriate, with the thickness being indicated in the Z-direction, the X axis being indicated as the machine direction (MD) and the Y axis being indicated as the cross, or cross machine, direction (CD) for ease of explanation. It should be recognized that an x-y plane designates a horizontal plane in the MD and CD directions, and a series of at least two configured X-Y zones (one over the other) create a gradient of zones in the Z-direction (out of plane). Alternatively, such materials may include at least three X-Y planar zones in the Z-direction.

In a first set of embodiments, as identified in FIGS. 1 and 2, which illustrate side cross-sectional views of absorbent materials in accordance with the invention, such integral web materials include front 70 and back 72 retention zones (identified as “C”). In FIG. 1, the retention zones C, 70 and 72 may comprise similar materials, but are separated by additional X-Y zones A, 78 and B, 80. X-Y zone B in this embodiment is subdjacent to zone A (out of plane zone in the Z direction). In an example of such an embodiment, the absorbent system includes within its upper X-Y plane Zone A a material of approximately 46% pulp, such as Caressa 1300 (Buckeye Technologies, Inc., Memphis, Tenn.), approximately 4% binder fiber such as T-255 (KoSa, Charlotte, NC) and approximately 50% of a superabsorbent, such as SXM 9543 available from Stockhausen, Inc. of Greensboro, N.C. The central region, labeled B, is designed for intake or distribution and zone C on each end is designed for distribution and retention. Zone B is composed of approximately 46% pulp, such as Caressa 1300, approximately 4% binder, such as T-255, and approximately 50% superabsorbent, such as SXM 9543. In one embodiment, Zone C is composed of approximately 46% of two pulps, for instance 23% pulp, such as NB-416 (Weyerhaeuser Company, Federal Way, Wash.), and 23% pulp such as Sulfatate HJ (S-HJ) (Rayonier Products and Financial Services Company, Fernandina Beach, Fla.) and approximately 4% binder such as T-255, and approximately 50% superabsorbent such as Favor® 880 available from Stockhausen of Greensboro, N.C. Alternatively, only one pulp could be utilized. It should be appreciated that while within the drawing figures the transitions between zones or gradients may be indicated by lines, it should not be taken to indicate sharp transitions in boundaries according to the present invention.

As seen in FIG. 1b, the shape of the lower X-Y zone of FIG. 1a is conformed somewhat to the shape of a diaper. In particular, the length of the sample is approximately 14.05 inches, and the widths at points 81, 82, and 84 is 4.20 inches, 2.47 inches and 6.10 inches respectively. The length of the respective zones is 6 inches, 5 inches, and 3 inches respectively, identified as 87, 89, and 91. The dimensions of the A X-Y zone, not shown, may be varied, but is usually rectangular in shape.

Other examples of such configured embodiments include the following:

Similar Zone A as described and having in Zone B approximately 42% pulp, such as Caressa 1300, approximately 8% binder such as T-255 and approximately 50% superabsorbent, such as SXM 9543. Zone C having approximately 46% of two pulps, such as 23% of a first pulp as NB-416 and 23% of a second pulp as Sulfatate HJ, and approximately 4% of a binder, such as T-255 and approximately 50% of a superabsorbent such as Favor® 880.

In FIG. 2, the retention zone C, 83 is continuous, but narrows 88 along the MD as it passes under X-Y zones A, 84 and B, 86. Zones A and B in this embodiment are adjacent to one another for almost their entire length.

It is expected that standard airlaid absorbent materials without such zoning, as well as traditional laminate-type separate materials, would demonstrate significantly poorer results than those just described, utilizing a cradle test. For instance, in running tests on Huggies® Ultratrim absorbent cores, Pampers® products and other airlaid layers, results of liquid distribution to positions above the 5 cm mark were not as effective as shown in the examples. Descriptions of such comparisons follow.

For each of the immediately preceding examples, the materials were made using a hand sheet former as previously described. For the examples, the testing was performed using a MIST test with x-ray. The MIST test included repetitive insults with 60 cc of fluid at 15 cc/sec, four times each, spaced 30 minutes apart. The materials were x-rayed prior to each insult and 30 minutes following the final insult. While no chassis was used in connection with the test, a single sheet of polyethylene film was used as a backsheet.

It should be noted that for each of the above embodiments, the zones are integrated as they are produced in-line. For instance, such materials could be produced on an airlaid line with three heads, by first forming the zones labeled as C, followed by zone B and eventually zone A. In the lafter embodiments described, zone A functions primarily as an intake zone, zone B functions primarily as a desorption/distribution zone, and zone C functions primarily as a retention zone.

For the purposes of this application, binders typically used in such structures help provide mechanical integrity and stabilization. Binders may include fiber, liquid or other binder means which in some instances may be thermally activated. Preferred fibers for inclusion are those having a relatively low melting point such as polyolefin fibers. Lower melting point polymers provide the ability to bond the fabric together at fiber cross-over points upon application of heat. In addition, fibers having a lower melting polymer, like conjugate and biconstituent fibers are suitable for the practice of this invention. Fibers having a lower melting polymer are generally referred to as “fusible” fibers. By “lower melting polymers” what is meant are those having a melting temperature less than 175 degrees C. It should be noted that the properties (such as texture) of the absorbent web can be modified from soft to stiff through the selection of the glass transition temperature of the polymer and the amount of binder fiber added. Exemplary binder fibers include conjugate fibers of polyolefins, polyamides and polyesters. Some suitable binder fibers are sheath core conjugate fibers available from KoSa Inc. (Charlotte, N.C.) under the designation T-255 and T-256 or copolyester designation, though many suitable binder fibers are known to those skilled in the art, and are available by many manufacturers such as Chisso Corp., Osaka Japan and Fibervisions LLC., of Wilmington, Del.

Cellulosic wood pulps include standard softwood fluffing grade such as CR-1654 from Bowater, Inc. of Greenville, S.C. Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea derivatives, dialdehydes such as maleic anhydride, non-methylolated urea derivatives, citric acid or other carboxylic acids. Pulp may also be stiffened by the use of heat or caustic treatments such as mercerization. Examples of these types of fibers include NHB416 which is a chemically crosslinked southern softwood pulp fiber which enhances wet modulus, available from the Weyerhaeuser Corporation of Federal Way, Wash. Other useful pulps are fully debonded pulp (NF405) and non-debonded pulp (NB416) and PH Sulfite pulp, also from Weyerhaeuser. HPZ3 from Buckeye Technologies, Inc. of Memphis, Term., has a chemical treatment that sets in a curl and twist, in addition to imparting added dry and wet stiffness and resilience to the fiber. Other suitable pulps include Sulfatate HJ from Rayonier Products and Financial Services Company, Caressa 1300 from Buckeye Technologies, Buckeye HPF2 pulp and still another is IP SUPERSOFT7 from International Paper Company of Purchase, N.Y.

Superabsorbents suitable for the present invention include SXM 9394, Favor SXM 880, and SP1284 available from Stockhausen, Inc., Greensboro, N.C. Multicomponent superabsorbents as described in U.S. Pat. Nos. 6,072,101; 6,087,448; and 6,194,631 B1 would also be suitable for the present invention since they have the capability to desalinate urine or other body exudates. The ions in body exudates tend to reduce the effectiveness of typical polyacrylic acid based superabsorbents, but the multicomponent superabsorbents in the above referenced patents have the ability to reduce the concentration of ions in the swelling solution by transporting the ions into the multicomponent superabsorbent particles. Therefore if the multicomponent superabsorbents were placed in the target zone (e.g. zone A in FIG. 1), then fluid entering the product would be desalinated in the target zone and fluid transported into subsequent zones (e.g. B and C in FIG. 1) would have a lower ion concentration than fluid initially entering the product, thus superabsorbents in the subsequent zones B and C would be more effective due to higher capacity. This is an example of a targeted waste system previously described.

It will be appreciated by those of skill in the art that various materials, as well as their amounts, and types, may be utilized according to the present invention to adapt the composite web to a variety of applications while remaining within the spirit of the present invention. For instance, functional agents or fluid modifiers may be added to particular zones as is described further below.

The following examples are meant to provide additional description of the inventive materials. The examples are not however meant to be limiting.

### TABLES AND SUMMARY OF EXAMPLES

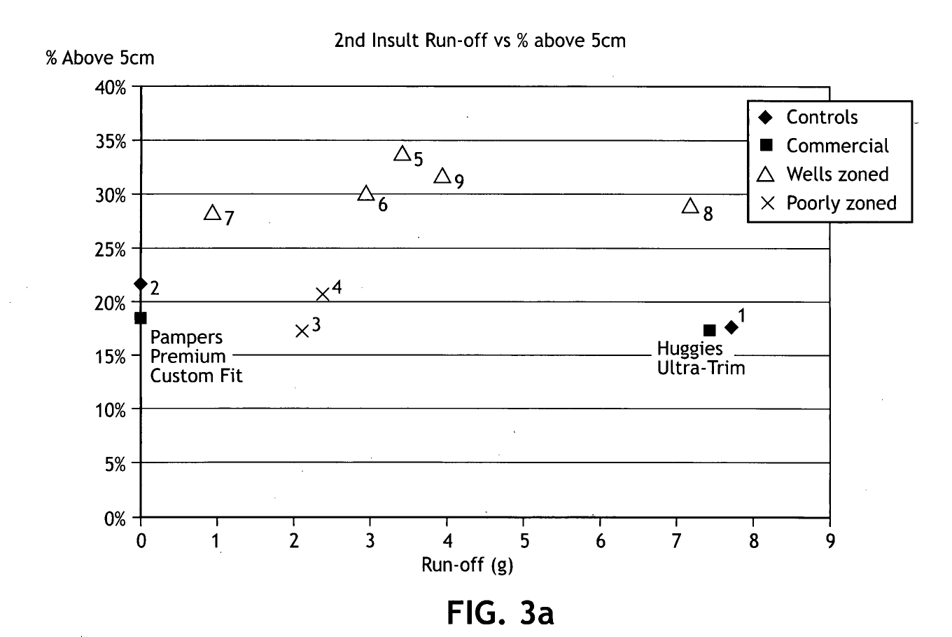

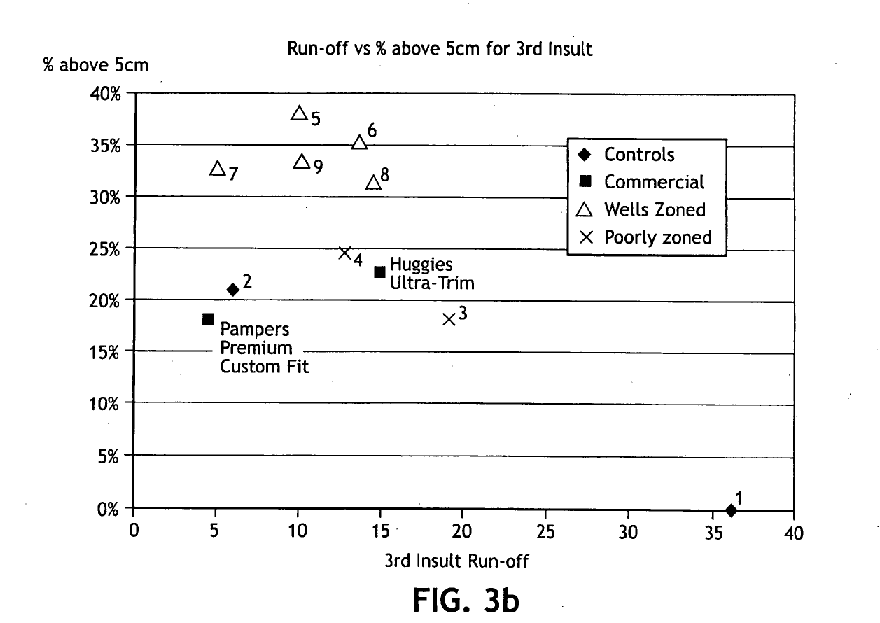

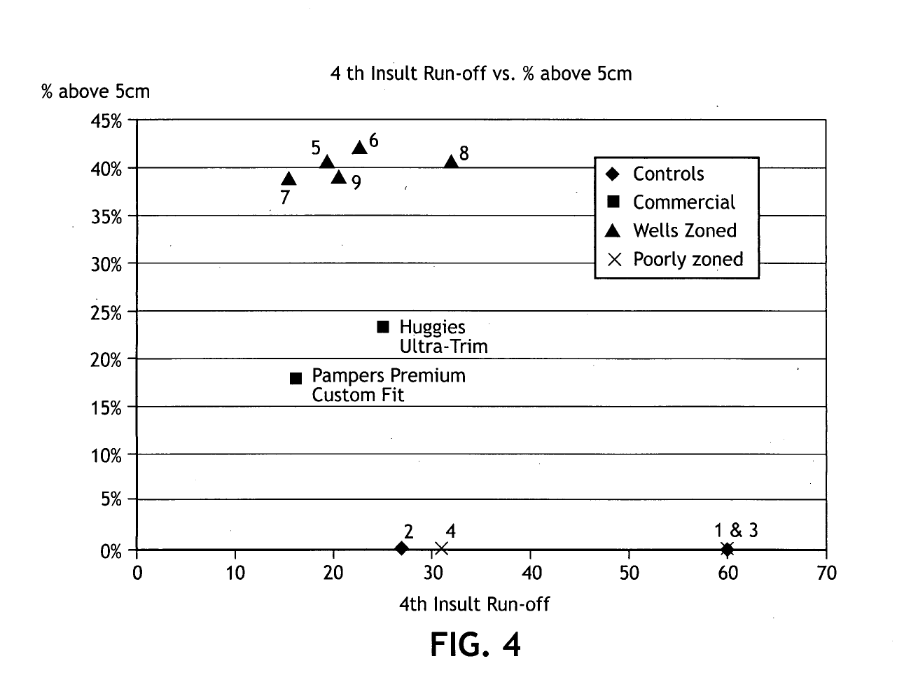

The results of MIST tests on these samples are reflected in FIGS. 3a-4 which illustrate the ranges of distribution (% above 5 cm) versus insult runoff. From the graphs, it can be seen that efficiently zoned materials perform better in MIST type testing than numerous controls, including existing non-integrally formed commercial embodiments and poorly zoned materials. The numbers on the graphs (data points) correlate to the numerical references in Tables 1-7, which follow, designating sample codes and properties of such.

In order to effectuate a highly efficient absorbent material it has been found desirable that the materials demonstrate the following ranges of properties. For the purposes of the Tables and Figures, the percent above 5 cm is indicative of the percent of total liquid in the material after a given insult, as measured by various methods, such as X-ray analysis that has been directed to the outermost areas of the product above the 5 cm mark. The run-off in grams, is the amount of run-off measured following each of the noted insults. The Examples designated by numbers are represented by the same numbers in the various graphs of FIGS. 3a through 4. Three controls were utilized for all tests. The controls consisted of various airformed materials where noted. For instance, the first control comprised an entirely airformed material of a first in plane zone of a homogeneous pledget material and a second out of plane zone of a homogeneous material. A second control comprised a material similar to the first control, but with binders. Likewise the third control comprised similar materials. Additionally, zoned materials that were not integrally formed were tested and compared with similar materials that were integrally formed.

TABLE 1

| | | Surf. Area | Coarseness | Permeability |
|---|---|---|---|---|
| Fiber | WRV (g/g)* | m²/g | (mg/100 m) | (um²) |
| NB 416 | 0.999 | 0.23 | 23.3 | 54 |
| Caressa | 0.835 | 0.214 | 24.2 | 73 |
| 1300 | | | | |
| CR 1654 | 1.01 | 0.257 | 18.15 | 48.4 |
| S-HJ | 0.892 | 0.338 | 10.3 | 28 |

*water retention value

TABLE 2

| | | | | | Binder | Binder |
|---|---|---|---|---|---|---|
| Compos. Mat'rl. | SAM % | SAM | Pulp % | Pulp | Fiber % | Fiber |
| 4A, 5A, 6A, 7A | 50 | SP | 46 | NB 416 | 4 | T-255 |
| 8A, 9A | | 1284* | | | | |
| 4C, 5C, 6C | 50 | SXM | 50 | S-HJ | n/a | — |
| 9B, 9C | | 9543 | | | | |
| 2AB, 3ABC, 4B, 5B | 50 | SXM | 46 | Caressa | 4 | T-255 |
| 7B, 8B | | 9543 | | 1300 | | |
| 8C | 50 | SXM | 46 | S-HJ | 4 | T-255 |
| | | 9543 | | | | |
| 7C | 50 | F880 | 50 | S-HJ | n/a | — |
| 1AB, 6B | 50 | SXM | 50 | Caressa | n/a | — |
| | | 9543 | | 1300 | | |

*SP 1284 of Stockhausen.

TABLE 3
Product Table
For the purposes of this Table 3, sample codes 3-9 have configuration
of FIG. 1a. The dimension of the “pledget” portion are 2.5 inch by
8 inch. The B zone was 5 inches and the C zone was 4.5 inches in front
and 7.5 inches in back.
In general, eleven codes were included in this study including two
commercial products (Huggies ™ and Pampers ™), two control
codes (1&2), two non-inventive examples (3&4), and five inventive
examples (5-9). General descriptions of these are listed below.

Huggies ™ UltraTrim ™ - step 3 - commercial product from 2002.
Pampers ™ Premium Custom Fit ™ - size 3 - commercial product
from 2002.
Sample 1 - Integrally formed, airformed control. One composition
throughout. Capacity was zoned toward the center.
Sample 2 - Two uniform (basis wt., density & composition) layers of
airlaid. One composition for both layers. Same capacity zoning as
sample 1.
Sample 3 - Two layers of airlaid, both having the same material
composition. In this sample, capacity in the lower layer (3b/c) was
shifted toward zone C.
Sample 4 - The three zones each have a different composition, and basis
weight. Lower layer capacity was shifted to zone C as in sample 3.
The zones were not produced integrally.
Sample 5 - Identical to sample 4 except that the zones were formed
integrally.
Sample 6 - Identical to sample 5 except that zone B does not contain
binder fiber which is replaced with 4% Caressa 1300 pulp.
Sample 7 - Identical to sample 5 except that zone C contains Favor 880
instead of SXM9543 (due to capacity differences this decreased the basis
weight in zone C).
Sample 8 - Identical to sample 5 except that 4% pulp is replaced with
binder fiber.
Sample 9 - Identical to sample 6 except that zone B contains S-HJ instead
of Caressa 1300.

| | Basis | | | | | | |
|---|---|---|---|---|---|---|---|
| | Weight | SAM | | Pulp | | Binder | Binder |
| Example | (gsm) | % | SAM | % | Pulp | Fiber % | Fiber |
| 1A | 415 | 50 | SXM | 50 | Caressa | n/a | — |
| | | | 9543 | | 1300 | | |
| 1B + C | 432 | 50 | SXM | 50 | Caressa | n/a | — |
| | | | 9543 | | 1300 | | |
| 2A | 415 | 50 | SXM | 46 | Caressa | 4 | T-255 |
| | | | 9543 | | 1300 | | |
| 2B + C | 432 | 50 | SXM | 46 | Caressa | 4 | T-255 |
| | | | 9543 | | 1300 | | |
| 3A | 415 | 50 | SXM | 46 | Caressa | 4 | T-255 |
| | | | 9543 | | 1300 | | |
| 3B | 253 | 50 | SXM | 46 | Caressa | 4 | T-255 |
| | | | 9543 | | 1300 | | |
| 3C | 505 | 50 | SXM | 46 | Caressa | 4 | T-255 |
| | | | 9543 | | 1300 | | |
| 4A | 431 | 50 | SP 1284 | 46 | NB 416 | 4 | T-255 |
| 4B | 253 | 50 | SXM | 46 | Caressa | 4 | T-255 |
| | | | 9543 | | 1300 | | |
| 4C | 550 | 50 | SXM | 50 | S-HJ | n/a | — |
| | | | 9543 | | | | |
| 5A | 431 | 50 | SP 1284 | 46 | NB 416 | 4 | T-255 |
| 5B | 253 | 50 | SXM | 46 | Caressa | 4 | T-255 |
| | | | 9543 | | 1300 | | |
| 5C | 550 | 50 | SXM | 50 | S-HJ | n/a | — |
| | | | 9543 | | | | |
| 6A | 431 | 50 | SP 1284 | 46 | NB 416 | 4 | T-255 |
| 6B | 270 | 50 | SXM | 50 | Caressa | n/a | — |
| | | | 9543 | | 1300 | | |
| 6C | 550 | 50 | SXM | 50 | S-HJ | n/a | — |
| | | | 9543 | | | | |
| 7A | 431 | 50 | SP1284 | 46 | NB 416 | 4 | T-255 |
| 7B | 253 | 50 | SXM | 46 | Caressa | 4 | T-255 |
| | | | 9543 | | 1300 | | |
| 7C | 456 | 50 | F880 | 50 | S-HJ | n/a | — |
| 8A | 431 | 50 | SP1284 | 46 | NB 416 | 4 | T-255 |
| 8B | 253 | 50 | SXM | 46 | Caressa | 4 | T-255 |
| | | | 9543 | | 1300 | | |
| 8C | 520 | 50 | SXM | 46 | S-HJ | 4 | T-255 |
| | | | 9543 | | | | |
| 9A | 426 | 50 | SP1284 | 46 | NB 416 | 4 | T-255 |
| 9B | 275 | 50 | SXM | 50 | S-HJ | n/a | — |
| | | | 9543 | | | | |
| 9C | 550 | 50 | SXM | 50 | S-HJ | n/a | — |
| | | | 9543 | | | | |

TABLE 4

| Composite Material | Density (g/cc) | Permeability (um²) |
|---|---|---|
| 4A, 5A, 6A, 7A, 8A, 9A | 0.129 | 155.5 |
| 4C, 5C, 6C, 9B, 9C | 0.14 | 29 |
| 2AB, 3ABC, 4B, 5B, 7B, 8B | 0.135 | 115.2 |
| 8C | 0.166 | 34.9 |
| 7C | 0.165 | 9 |
| 1AB, 6B | 0.129 | 82.7 |

TABLE 5

| | | | Permeability | Permeability |
|---|---|---|---|---|
| | | | Difference | Difference |
| | | | Between | Between |
| | Integrally | Target Zone | Zones | Zones |
| | Formed | Permeability | (um²) | (um²) |
| Example | (yes or no) | (um²) | A to B | B to C |
| 1 | Yes | 83 | 0 | 0 |
| 2 | No | 115 | 0 | 0 |
| 3 | No | 115 | 0 | 0 |
| 4 | No | 111 | 40 | 86 |
| 5 | Yes | 111 | 40 | 86 |
| 6 | Yes | 69 | 73 | 54 |
| 7 | Yes | 111 | 40 | 106 |
| 8 | Yes | 111 | 40 | 80 |
| 9 | Yes | 54 | 127 | 0 |
| Huggies ® | Yes | 6 | — | — |
| Ultratrim | | | | |
| Pampers ® | Believed to be | 31 | — | — |
| Premium | | | | |
| Custom Fit | | | | |

TABLE 6

| | 2^{nd} | | 3^{rd} | | | |
|---|---|---|---|---|---|---|
| | Insult | % Fluid | Insult | % Fluid | 4^{th} Insult | % Fluid |
| | Runoff | above 5 | Runoff | above 5 | Runoff | above 5 |
| Example | (ml) | cm (%) | (ml) | cm (%) | (ml) | cm (%) |
| 1 | 7.73 | 17.6 | 36.2 | 0.0 | 60.0 | 0.0 |
| 2 | 0.00 | 21.6 | 5.8 | 21.0 | 27.0 | 0.0 |
| 3 | 2.11 | 17.3 | 19.0 | 0.0 | 60.0 | 0.0 |
| 4 | 2.37 | 20.8 | 12.5 | 32.7 | 31.0 | 0.0 |
| 5 | 3.41 | 33.8 | 9.9 | 68.0 | 19.4 | 79.7 |
| 6 | 2.94 | 30.0 | 13.3 | 60.2 | 22.6 | 81.7 |
| 7 | 0.94 | 28.5 | 4.9 | 47.7 | 15.6 | 65.1 |
| 8 | 7.14 | 29.0 | 14.3 | 53.9 | 31.9 | 82.8 |
| 9 | 3.94 | 31.8 | 10.0 | 56.6 | 20.5 | 74.2 |
| Huggies ® | 7.42 | 17.4 | 14.7 | 21.9 | 25.1 | 25.1 |
| Ultratrim | | | | | | |
| Pampers ® | 0.00 | 18.5 | 4.3 | 17.0 | 16.3 | 17.9 |
| Premium | | | | | | |
| Custom Fit | | | | | | |

The Kimberly-Clark Huggies® samples were tested with a surge and liner layer removed. Pampers® samples were tested with the liner and outer cover removed from size 3 Pampers Custom Fit Cruisers®. The transfer layer and curly fibers remained in place.

As can be seen from the examples, in an alternative embodiment, the integral web or material may have at least two zones in the Z-direction. In still another alternative embodiment, the integral web or material may have at least three zones in an X-Y plane, and at least three zones in the Z-direction.

In still a further alternative embodiment, the integral web or material demonstrates zoning such that greater than 25 percent of the total liquid in the material is above 5 cm in height, after the second insult, with a run-off of less than 10 g in accordance with the MIST test. In still a further alternative embodiment, the integral web or material demonstrates zoning such that greater than 30 percent of the total liquid in the material is above 5 cm in height, after the second insult, with a run-off of less than 6 g in accordance with the MIST test. In still a further alternative embodiment, the integral web or material is above 5 cm in height after the second insult, with a run-off of less than 4 g in accordance with the MIST test.

In still a further alternative embodiment, the integral web or material demonstrates zoning such that greater than 25 percent of the total liquid in the material is above 5 cm in height, after the third insult, with a run-off of less than 30 g in accordance with the MIST test. In still a further alternative embodiment, the integral web or material demonstrates zoning such that greater than 30 percent of the total liquid in the material is above 5 cm in height after the third insult, with a run-off of less than 20 g in accordance with the MIST test. In still a further alternative embodiment, the integral web or material demonstrates zoning such that greater than 35 percent of the total liquid in the material is above 5 cm in height, after the third insult, with a run-off of less than 15 g in accordance with the MIST test.

In still a further alternative embodiment, the integral web or material demonstrates zoning such that greater than 25 percent of the total liquid in the material is above 5 cm in height after the fourth insult, with a run-off of less than 45 g in accordance with the MIST test. In still a further alternative embodiment, the integral web or material demonstrates zoning such that greater than 35 percent of the total liquid in the material is above 5 cm in height, after the fourth insult, with a run-off of less than 35 g in accordance with the MIST test. In still a further alternative embodiment, the integral web or material demonstrates zoning such that greater than 40 percent of the total liquid in the material is above 5 cm in height after the fourth insult, with a run-off of less than 25 g in accordance with the MIST test.

These ranges are summarized in the following Table 7.

TABLE 7

% of total liquid

| | above 5 cm | run-off (g) |
|---|---|---|
| After 2nd Insult | >25% | <10 |
| | >30% | <6 |
| | >32% | <4 |
| After 3rd Insult | >25% | <30 |
| | >30% | <20 |
| | >35% | <15 |
| After 4th Insult | >25% | <45 |
| | >35% | <35 |
| | >40% | <25 |

In another embodiment of the inventive zoned materials, an integrally formed absorbent material includes at least two in plane X-Y zones and at least two out of plane zones in the Z-direction having a Z-directional permeability difference between these zones of at least 40 um². In still a further embodiment of this material an integrally formed absorbent is composed of at least two “regions” in-plane and at least two “regions” out-of-plane with a target zone permeability of at least about 50 um². In still another alternative embodiment the integrally formed absorbent material is composed of at least two zones in-plane and at least two zones out-of-plane with the in plane zones (x-y direction) demonstrating permeability differences of greater than about 40 um² and the out of plane zones (z-direction) demonstrating a permeability difference of greater than about 54 um². In still another alternative embodiment, it is desirable that an intake zone would be composed of high permeability pulp fibers at a percentage ranging from 40-85 percent, binder fibers ranging from 0-20 percent, superabsorbent material ranging from 5 to 60 percent and other treatments or materials ranging from 0-15 percent by weight. Such additional materials could address odor control, fluid modification, ion reduction, or other desirable functionalities for the purposes of improved intake and distribution as described in the application. In still a further alternative embodiment, a desirable fluid retention zone could be composed of high capillarity pulp fibers at a percentage ranging from 40-85 percent, binder fibers ranging from 0-20 percent and superabsorbent materials ranging from 30-85 percent by weight.

In still a further alternative embodiment of the present invention, an integrally formed web or material includes at least two in plane X-Y zones in the MD and CD direction and at least two out of plane zones in the Z-direction, on top of one another with zones including different components. In this structure, adjacent zones have different pulp fibers such that the coarseness ratio of the two fibers is greater than 1. For instance, in one embodiment the coarseness ratio is greater than 1.5:1. In a second alternative embodiment, the coarseness ratio is greater than 2:1. This difference in coarseness translates into differences in the fiber surface area (per unit mass) in the two zones. These differences in surface area result in differences in the capillary pressure between the two zones, and hence the ability to move fluid more effectively from one zone into an adjacent zone.

In still further embodiments, the material components can be positioned in the zones such that the zones can interact with each other in an efficient fashion. For instance, superabsorbent materials designed to reduce the salinity of urine can be positioned in either zone A or B to allow suberabsorbent materials which might encounter the urine later in time (zones B and C or just C) to absorb more fluid (capacity). Such an arrangement would result in an improved efficiency of the material. Another example of alternate embodiments based on differing components, include the use of more zones in either the upper X-Y plane or the lower X-Y plane. By using fibers of different contact angles in adjacent zones, the capillary pressure of adjacent zones can be controlled in order to effectively move fluid from one zone into an adjacent zone.

In still a further alternative embodiment, the integrally formed absorbent material may also contain other additives or functionally active agents/materials that have an affect on the body waste stream which is exposed to the absorbent material. Such materials may include without limitation, odor control agents, ion-exchange agents and fluid modifiers. These agents are desirably zoned in areas of the absorbent material to maximize their effectiveness and to minimize overall cost. For example, fluid modifying agents may be more beneficially situated in the zone closest to a user (upper most zone, Zone A) since the liquid is expected to enter the material in that area and the effectiveness of modification would be done most efficiently at that location. Odor control agents may be situated along the bottom of the lowest out of plane zone (Zone B) in order to most effectively function where waste products/exudates are maintained for an extended period of time. Functional agents may be placed in more than one zone and may help to form a compositional gradient within a zone or between zones. In addition, more than one active agent may be incorporated within the structure as required to achieve the desired functions. As a further example, ion-exchange agents, such as any of a number of Dowex ion exchange resins available from Aldrich Chemical Company, Inc. of Milwaukee, Wis. may be utilized to change the characteristics of the waste product/exudates at different zones within the material.

In one embodiment, alternative fluid treatment agents may be added in one or more zones of the absorbent composite. Examples of suitable fluid treatment agents such as those that cause red blood cells in a blood-containing fluid to agglomerate or lyse are disclosed in U.S. Pat. No. 6,350,711 which is hereby incorporated by reference in its entirety.

In still a further alternative embodiment, a specific zone or zones of the absorbent composite may be treated with a viscoelastant treatment. Such a treatment alters the viscoelastic properties of a viscoelastic fluid such as menses in order to enhance fluid movement in the absorbent composite. Examples of such suitable treatments are disclosed in U.S. Pat. No. 6,060,636 which is incorporated by reference hereto in its entirety.

In still a further embodiment, the absorbent structure may be manufactured using a wetlaid process such as that described in U.S. Pat. No. 5,651,862 which is incorporated by reference herein in its entirety. The relative placement of various raw materials such as superabsorbent and fiber may be controlled in the X-Y plane and Z-direction of a base web forming machine, using a divided headbox and using multiple forming stations prior to drying the web.

In still another alternative embodiment, the absorbent structure may be manufactured using a foam process. Foams may be formed using various approaches well known in that art, such as High Internal Phase Emulsion (HIPE), freeze-drying, thermoset polyurethane foams, and continuous extrusion, from a variety of thermoplastic, natural and synthetic polymers. The structure of foams is typically controlled by the polymer selection and process conditions. For example U.S. Pat. No. 5,856,366 which is also incorporated in its entirety by reference herein, describes a process for making heterogeneous HIPE foams that have distinct regions of prescribed properties. Zone C in FIG. 2 may be formed in the desired X-Y shape and uniform thickness. Upon partial curing, a portion of this may be extracted and the space filled in with Zones B and A sequentially with HIPEs of different composition and/or structure. Alternately, U.S. Pat. No. 5,948,829, which is incorporated herein by reference in its entirety, describes a process to make an absorbent foam using freeze-drying. An absorbent structure of the present invention may be obtained by combining two or more compositions of the solution of the type described in the above mentioned patent prior to freeze-drying in such a fashion that they are in intimate contact, but not mixed homogeneously. The rate, order, and location where these various solutions are added will dictate the size and position of the various zones in the absorbent structure. The properties of the zones will depend on the composition of the solutions used.

As will be appreciated by those skilled in the art, changes and variations to the invention are considered to be within the ability of those skilled in the art. Such changes and variations are intended by the inventors to be within the scope of the invention.

1. An integrally formed absorbent web or material comprising at least two zones in plane and at least two zones out of plane in the Z-direction, wherein said integrally formed web or material demonstrates greater than 25 percent of the total liquid in the web or material above 5 cm in height after the second insult, with a run-off of less than 10 g in accordance with the MIST test.

2. The integrally formed absorbent web or material of claim 1 comprising at least two zones in plane and at least three zones out of plane in the Z-direction.

3. The integrally formed absorbent web or material of claim 1 wherein said integrally formed web or material demonstrates greater than 30 percent of the total liquid in the material above 5 cm in height after the second insult, with a run-off of less than 6 g in accordance with the MIST test.

4. The integrally formed absorbent web or material of claim 1 wherein the integrally formed web or material demonstrates greater than 32 percent of the total liquid in the material above 5 cm in height after the second insult, with a run-off of less than 4 g in accordance with the MIST test.

5. The integrally formed absorbent web or material of claim 1 wherein the integrally formed web or material demonstrates greater than 25 percent of the total liquid in the material above 5 cm in height after the third insult, with a run-off of less than 30 g in accordance with the MIST test.

6. The integrally formed absorbent web or material of claim 1 wherein the integrally formed web or material demonstrates greater than 30 percent of the total liquid in the material above 5 cm in height after the third insult, with a run-off of less than 20 g in accordance with the MIST test.

7. The integrally formed absorbent web or material of claim 1 wherein the integrally formed web or material demonstrates greater than 35 percent of the total liquid in the material above 5 cm in height after the third insult, with a run-off of less than 15 g in accordance with the MIST test.

8. The integrally formed absorbent web or material of claim 1 wherein the integrally formed web or material demonstrates greater than 25 percent of the total liquid in the material above 5 cm in height after the fourth insult, with a run-off of less than 45 g in accordance with the MIST test.

9. The integrally formed absorbent web or material of claim 1 wherein the integrally formed web or material demonstrates greater than 35 percent of the total liquid in the material above 5 cm in height after the fourth insult, with a run-off of less than 35 g in accordance with the MIST test.

10. The integrally formed absorbent web or material of claim 1 wherein the integrally formed web demonstrates greater than 40 percent of the total liquid in the material above 5 cm in height after the fourth insult, with a run-off of less than 25 g in accordance with the MIST test.

11. An integrally formed absorbent material composed of at least two zones in-plane, one being a target in plane zone, the other being a non-target in plane zone, and at least two zones out-of-plane, with two adjacent out of plane zones having a z-directional permeability difference of at least 40 um².

12. The integrally formed absorbent material of claim 11 wherein said in plane zones demonstrate permeability differences of greater than about 40 um² and said out of plane zones demonstrate a permeability difference of greater than about 54 um².

13. The integrally formed absorbent material of claim 11 wherein said absorbent material includes a user facing surface and a garment facing surface, and wherein said out of plane zone on said user facing surface demonstrates a higher permeability than said out of plane zone closest to said garment facing surface.

14. The integrally formed absorbent material of claim 11 wherein said target in plane zone demonstrates a higher permeability than said non-target in plane zones.

15. An integrally formed absorbent material composed of at least two zones in-plane and at least two zones out-of-plane with a target zone permeability of at least about 50 um².

16. An integrally formed absorbent material composed of at least two zones in-plane and at least two zones out-of-plane in which two adjacent zones have different pulp fibers such that the coarseness ratio of the two fibers is >1.

17. An integrally formed absorbent material composed of at least two in plane zones and at least two out of plane zones in the z-direction in which two adjacent zones have substantially different types of fibers wherein the different types of fibers vary in their contact angle, so as to create a difference in the capillary pressure between adjacent zones in order to improve fluid movement from one zone to another.

18. An integrally formed absorbent material composed of at least two in plane zones and at least two out of plane zones in the z-direction in which one or more of the zones contains a material designed to decrease the ionic strength of a body exudate.

19. An integrally formed absorbent material composed of at least two in plane zones and at least two out of plane zones in the z-direction in which one or more of the zones contains a material designed to substantially increase or decrease the viscosity or viscoelasticity of a body exudate.

20. An integrally formed absorbent web or material in accordance with claim 1 wherein at least one of said in plane zones includes an active agent.

21. An integrally formed absorbent web or material in accordance with claim 1, which is incorporated into an absorbent article.
